(19) United States
(12) Patent Application Publication
(10) Pub. No.: US 2008/0202239 A1
(43) Pub. Date: Aug. 28, 2008

(54) Piezoelectric acceleration sensor

(76) Inventors: R. Shane Fazzio, Loveland, CO (US); Kristina L. Lamers, Fort Collins, CO (US); Atul Goel, Ft. Collins, CO (US)

Correspondence Address: Kathy Manke;Avago Technologies Limited, 4380 Ziegler Road, Fort Collins, CO, 80525, US

(21) Appl. No.: 11/712,575

(22) Filed: Feb. 28, 2007

(51) Int. Cl. G01P 15/09; G01P 15/14

(52) U.S. Cl. 73/504.18; 73/514.34

(57) ABSTRACT

Piezoelectric accelerometers and gyroscopes having cantilevered transducers are described.

### BACKGROUND

Accelerometers and gyroscopes are useful in a variety of applications including motion detection and motion compensation. Additionally, certain applications require accelerometers and gyroscopes of comparatively small dimensions. For example, video and still cameras beneficially include gyroscopes to detect angular motion (pitch, yaw and rotation) caused by user movement.

### SUMMARY

In accordance with an illustrative embodiment an accelerometer includes a substrate having a cavity, a cantilevered transducer disposed over the cavity and having an upper electrode, a lower electrode and a piezoelectric element therebetween. An acceleration causes a movement of the cantilevered transducer that is proportional to a magnitude of the acceleration.

In accordance with another illustrative embodiment, an accelerometer includes a substrate having a cavity with a lower surface, and a side surface. The accelerometer also includes a cantilevered transducer comprising: a piezoelectric element having an upper surface and a lower surface; a first edge electrode and an upper electrode each disposed over the upper surface; and a lower electrode disposed over the lower surface of the piezoelectric element. In addition, the accelerometer includes a second edge electrode disposed over the side surface of the cavity; and an electrode disposed over the lower surface of the cavity.

In accordance with another representative embodiment, a gyroscope includes a substrate having a cavity. A cantilevered transducer is disposed over the cavity and includes an upper electrode, a lower electrode and a piezoelectric element therebetween.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1A is a cross-sectional view of an accelerometer structure in accordance with a representative embodiment.

FIG. 1B is a top view of an accelerometer structure in accordance with a representative embodiment.

FIG. 1C is a cross-sectional view of an accelerometer structure in accordance with a representative embodiment.

FIG. 1D is a top-view of an accelerometer structure in accordance with a representative embodiment.

FIG. 2 is a top view of an accelerometer structure in accordance with a representative embodiment.

FIG. 3A is a simplified schematic shows a modified Butterworth-Van Dyke equivalent circuit model for a resonator in accordance with a representative embodiment.

FIG. 3B is a cross-sectional view of an accelerometer in accordance with a representative embodiment.

FIG. 3C is a simplified schematic shows a modified Butterworth-Van Dyke equivalent circuit model for a resonator in accordance with a representative embodiment.

FIG. 4 is a top view of an accelerometer structure in accordance with a representative embodiment.

### DEFINED TERMINOLOGY

The terms ‘a’ or ‘an’, as used herein are defined as one or more than one.

The term ‘plurality’ as used herein is defined as two or more than two.

The term ‘cantilevered transducer’ as used herein includes a membrane disposed over a cavity and attached at least partially about a perimeter of the cavity. The membrane comprises a piezoelectric layer disposed between electrodes.

### DETAILED DESCRIPTION

In the following detailed description, for purposes of explanation and not limitation, specific details are set forth in order to provide a thorough understanding of example embodiments according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of hardware, software, firmware, materials and methods may be omitted so as to avoid obscuring the description of the illustrative embodiments. Nonetheless, such hardware, software, firmware, materials and methods that are within the purview of one of ordinary skill in the art may be used in accordance with the illustrative embodiments. Such hardware, software, firmware, materials and methods are clearly within the scope of the present teachings.

The accelerometers and gyroscopes described in connection with representative embodiments are contemplated for use in a wide variety of sensing, control and correction applications in motor vehicles, consumer electronics, industrial equipment and manufacturing, to mention only a few. For example, the accelerometers and gyroscopes may be used for vehicle stability sensing, video equipment motion compensation, robotic vehicle motion, and avionic gyroscope applications. It is emphasized that the noted applications are merely illustrative, and that other applications within the purview of one of ordinary skill in the art having had the benefit of the present disclosure are contemplated.

Illustratively, the accelerometers and gyroscopes of the representative embodiments may be micromachined using methods referenced herein as well as other methods known to those of ordinary skill in the micro-electromechanical systems (MEMS) arts. Beneficially, the accelerometers and gyroscopes can be fabricated in comparatively small dimensions, thereby fostering their use in many electronics applications where component size is a factor. Moreover, the accelerometers and gyroscopes may be fabricated in large scale (e.g., wafer scale) fabrication.

Furthermore, a variety of materials may be used in fabricating the accelerometers and gyroscopes of the representative embodiments. Notably, the substrates of the representative embodiments may be semiconductor materials such as silicon; the piezoelectric materials may be AlN, ZnO, lead zirconium titanate (PZT) or combinations thereof; the electrodes may be metal such as Al, Mo, Pt, Au or metal alloys; and the mass loading layers may be dielectrics, ceramics, piezoelectric materials and metals. It is emphasized that the noted materials are merely illustrative.

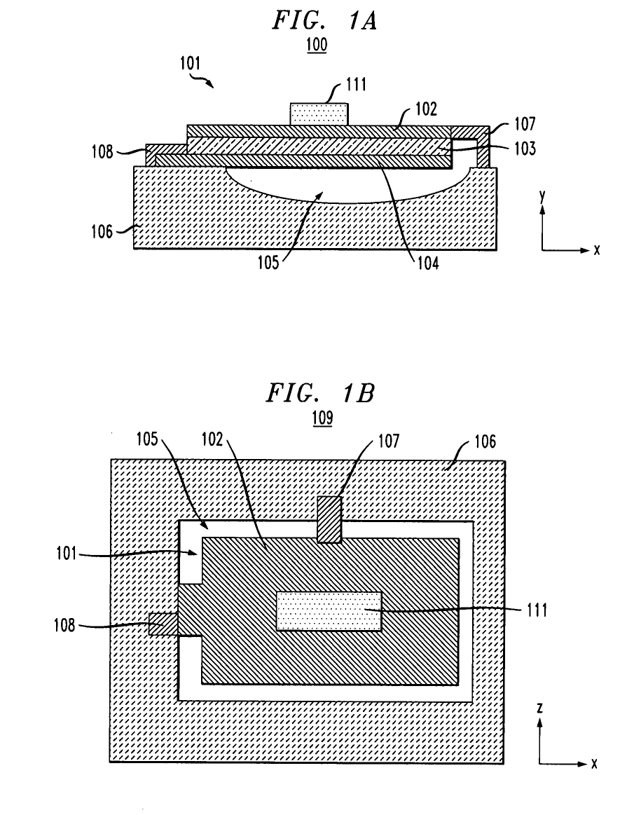

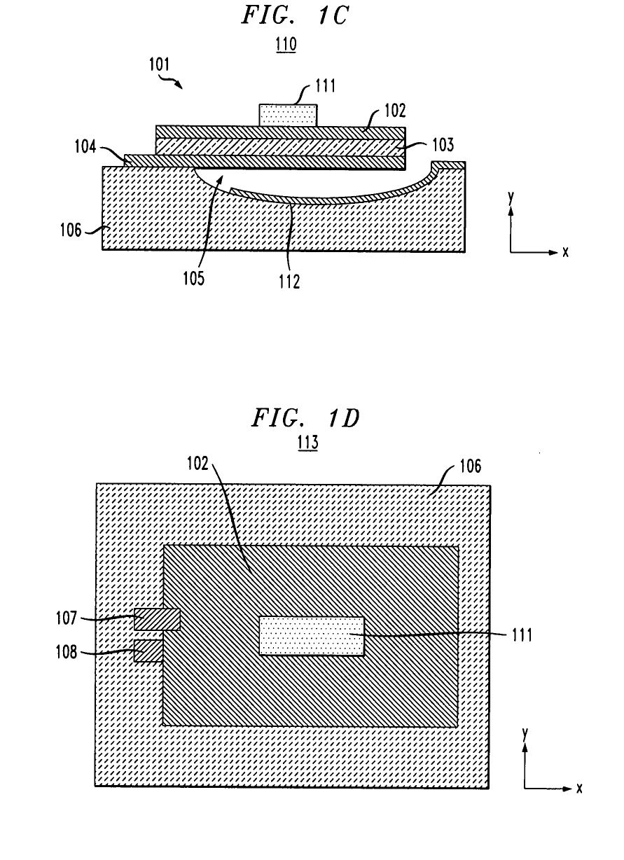

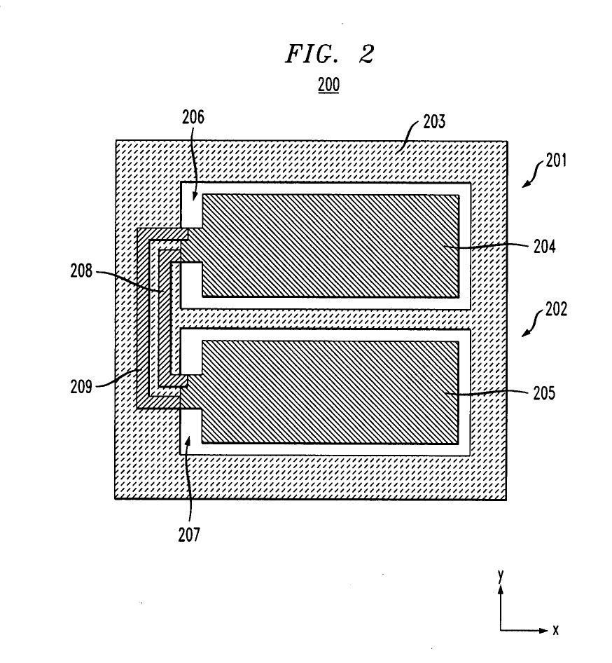

FIG. 1A is a cross-sectional view of an accelerometer 100 in accordance with a representative embodiment. The accelerometer includes a cantilevered transducer 101, having an upper electrode 102, a piezoelectric element 103 and a lower electrode 104. The cantilevered transducer 101 is formed over a cavity 105 in a substrate 106. Illustratively, but not necessarily, the areal shape of the cavity 105 is substantially identical to the areal shape of the cantilevered transducer 101. In the interest of brevity of description, the cantilevered transducers of representative embodiments have a rectangular areal shape. It is emphasized that many other areal shapes are contemplated. For example, the cantilevered transducers of representative embodiments may comprise elliptically-shaped (and thus circularly-shaped) electrodes and piezoelectric elements. Alternatively, the upper and lower electrodes 102, 104 may be apodized. Further details of apodization may be found in: U.S. Pat. No. 6,215,375 to Larson III, et al; “The Effect of Perimeter Geometry on FBAR Resonator Electrical Performance” to Richard Ruby, et al. Microwave Symposium Digest, 2005 IEEE MTT-S International, pages 217-221 (Jun. 12, 2005); and U.S. patent application Ser. No. 11/443,954, filed May 31, 2006 and entitled “PIEZOELECTRIC RESONATOR STRUCTURES AND ELECTRICAL FILTERS” to Richard C. Ruby, et al. The disclosures of this patent, paper and patent application are specifically incorporated herein by reference in their entirety.

Still alternatively, the areal shape of the cantilevered transducers may be square or may be of an irregular shape. The noted areal shapes are intended only to be illustrative and in no way limiting of the possible cantilevered transducer shapes. Furthermore, and as will be appreciated upon review of the present description, attachment to the edge(s) of the cavity 105 can depend on the areal shape of the cantilevered transducer. For example, a rectangular areal shaped cantilevered transducer may be attached on one or more sides thereof to one or more corresponding edges of the cavity 105. By contrast, an elliptical areal shaped cantilevered transducer may be connected at least partially about the perimeter of the cavity 105.

In certain representative embodiments, the cantilevered transducer 101 may comprise a cantilevered piezoelectric structure such as described in U.S. Pat. No. 6,384,697 entitled “Cavity Spanning Bottom Electrode of Substrate Mounted Bulk Wave Acoustic Resonator” to Ruby, et al. and assigned to the present assignee. The disclosure of this patent is specifically incorporated herein by reference.

Illustratively, a known deep reactive ion etching (DRIE) method, such as the Bosch Method, may be used to form the cavity 105. Sacrificial material may then be provided in the cavity 105 for fabrication of the cantilevered transducer 101 in a similar manner as described in the referenced patent to Ruby, et al.; or as described in co-pending and commonly assigned U.S. patent application entitled “Piezoelectric Microphones” to R. Shane Fazzio, et al., having Ser. No. 11/588,752. This application, filed Oct. 27, 2006, is specifically incorporated herein by reference.

In certain embodiments, it may be useful for the electrodes 102,104 to be of dissimilar materials. Alternatively, or additionally, the thickness of the electrodes may be different. Moreover, a mass loading layer 111 is optionally provided and may be used to modify the location of the neutral axis of the cantilevered transducer 101 with respect to the piezoelectric element 103. The mass loading layer 111 may be disposed substantially coincident with or near the geometric center of the upper electrode 102 (as shown); or over substantially the entire surface of the upper electrode 102; or in other locations over the upper electrode electrodes. As will become clearer as the present description continues, among other effects, electrodes of dissimilar materials, electrodes of differing thicknesses, and mass loading may function to provide proof masses and to provide an asymmetry in the transducer 101.

Displacement of the piezoelectric element 103 and the charge displacement in the piezoelectric element 103 are augmented through the use of mass loading layer 111 or dissimilar electrodes, or both, allowing for the generation of a signal of sufficient magnitude during deflection to provide a proper measure of the acceleration. In addition, the resonance frequency of the cantilevered transducer 101 may be modified by the mass loading layer 111. Additional details of mass loading layer 111 may be found in U.S. Pat. No. 6,469,597, entitled “Method of Mass Loading of Thin Film Bulk Acoustic Resonators (FBAR) for Creating Resonators of Different Frequencies and Apparatus Embodying the Method” to Ruby, et al. The disclosure of this patent is specifically incorporated herein by reference.

In operation, a force along the +y-direction of the coordinate system shown in FIG. 1A will result in a reaction force along the −y-direction. This reaction force results in a flexure of the cantilevered transducer 101; charge displacement in the piezoelectric element 103; and a resultant voltage difference between the upper and lower electrodes 102,104. The magnitude of the force is proportional to the acceleration, and the induced voltage is proportional to the force and thus the acceleration.

As will be appreciated by one of ordinary skill in the art, the optional mass loading layer 111 disposed substantially coincident with or near the geometric center of the upper electrode 102 serves to increase the mass and thus the reactionary force. The augmented reactionary force increases the charge displacement in the piezoelectric element 103 and thereby the induced voltage. This beneficially improves the sensitivity of the accelerometer 101.

The accelerometer 101 of the presently described representative embodiment is also adapted to detect an acceleration along a second axis. In particular, in the present embodiment the upper electrode 102 is connected to the substrate 106 by a contact 107 and the lower electrode 104 is connected to the substrate 106 by a contact 108. If an acceleration is in the +z-direction (i.e., into and out of the plane of the page), the reactionary force creates a shearing action between the upper and lower electrodes 102, 103 that results in a shear force on the piezoelectric element 103 indicative of the acceleration along the z-axis. Moreover, an acceleration in the y-direction will create a shear stress in 103 due to pinning of electrodes 102,104 on opposite sides of the cavity 105. Beneficially, the optional mass loading layer 111 augments or magnifies the shearing action between the upper and lower electrodes 102, 103 and thus the induced voltage.

In a representative embodiment, the upper electrode contact 107 and the lower electrode contact 108 connect respective electrodes 102, 104 to circuitry (not shown) adapted to provide an output based on the acceleration. The circuitry adapted to process a signal indicative of the acceleration (e.g., direction and magnitude) may be one of a variety of circuits/components known to one of ordinary skill in the art. Details of this circuitry are generally omitted to avoid obscuring the description of the representative embodiments.

It is emphasized that the placement of the upper electrode contact 107 from the substrate 106 to the upper electrode 102 of the accelerometer 101 may be other than shown in FIG. 1A. For example, the contact 107 to the upper electrode 102 may be disposed on the same side of the accelerometer as the contact 108. In this case, the accelerometer 101 functions as a uniaxial accelerometer, measuring acceleration along the y-axis in the illustrated coordinate system. As will be appreciated by one skilled in the art, this arrangement of electrodes 107, 108 will foster comparatively greater flexure of the cantilevered transducer 101.

FIG. 1B is a top view of the accelerometer 109 in accordance with another representative embodiment. The accelerometer 109 includes many features and details common to the accelerometers described in connection with FIG. 1A. The description of these common features and details is generally omitted to avoid obscuring the description of the present embodiment.

In the present embodiment, the upper electrode contact 107 is disposed along a different side of the accelerometer 109. Like the accelerometer 101, the accelerometer 109 is adapted to measure acceleration in two directions, illustratively along the y-axis and along the z-axis in substantially the same manner as described in connection with the representative embodiments of FIG. 1A.

FIG. 1C is a cross-sectional view of the accelerometer 110 in accordance with another representative embodiment. The accelerometer 110 includes many features and details common to the accelerometers described in connection with FIGS. 1A and 1B. The description of these common features and details is generally omitted to avoid obscuring the description of the present embodiment. However, unlike the previously described embodiments, the accelerometer 110 also includes an electrode 112 disposed along a lower surface of the cavity 105. The lower electrode 104 and the electrode 112 form a capacitor, which is connected in parallel with the transducer 101.

In a representative embodiment, the cantilevered transducer 101 and capacitor connected in parallel form a resonant circuit useful in providing an indication of a linear acceleration of the accelerometer 109 and the magnitude thereof. In particular, in one embodiment, a time-varying electrical (carrier) signal is applied to the transducer 101. This signal causes the transducer 101 to oscillate. Upon movement due to acceleration along the y-axis, the lower electrode 104 is moved closer to or farther away from the electrode 110, depending on the direction of the acceleration along the y-axis. The change in the distance between the electrodes (plates of the capacitor) 104,110 and change in the charge displacement in the piezoelectric element result in a variation in the capacitance of the resonant circuit and modulation of the output signal of the resonant circuit. The modulation of the output may be provided to circuitry (not shown) indicative of an acceleration (e.g., direction, or magnitude, or both) as desired.

FIG. 1D is a top view of an accelerometer 113 in accordance with another representative embodiment. The accelerometer 113 includes many features and details common to the accelerometers described in connection with FIGS. 1A-1C. The description of these common features and details is generally omitted to avoid obscuring the description of the present embodiment.

The previously described accelerometers include cantilevered transducers disposed over a cavity in a substrate and connected at least partially about the perimeter (e.g., to one or two sides) of the substrate, for example by contacts 107, 108. However, as shown in FIG. 1D, connection about substantially the entire perimeter of the cavity (not shown) is also contemplated. Notably, the upper electrode 102 may be disposed over the cavity and attached to the substrate 106 directly. Naturally, in such an embodiment, the piezoelectric element and the lower electrode (not shown in FIG. 1D) would extend into the cavity somewhat. Alternatively, the upper electrode 102 may be attached to the substrate 106 via a connection to an upper electrode contact (not shown), in much the same manner (albeit about the perimeter) that contact 107 is connected to the upper electrode 102 in FIGS. 1A and 1B.

In representative embodiments, the accelerometers 101, 109, 110 or 113 may be provided in an electronic device and are adapted to provide a simple security feature. For example, the accelerometers 101,109 may be provided in a cell phone or personal digital assistant (PDA) having a global positioning function. The device may then be disposed in an item of value (e.g., luggage). If the item is moved by a would-be thief, an acceleration results in an alarm signal and ready tracking due to the GPS capability. It is emphasized that this is merely an illustrative implementation of the accelerometers 101,109 and, as noted previously, that many other applications are contemplated.

In the representative embodiment described in connection with FIG. 1C, the transducer 110 oscillates at a frequency that is illustratively on the order of GHz. The variation in the capacitance due to movement of the lower electrode 104 caused by an acceleration provides a perturbation/modulation on the carrier signal on the order of kHz. While discerning this modulation in the dedicated circuitry or electronics can be effected, it may require comparatively sophisticated and comparatively expensive electronics. As such, it may be useful to further process the output signal from the resonant circuit comprising the transducer 101 and variable capacitor.

FIG. 2 is a top view of an accelerometer 200 in accordance with a representative embodiment. The accelerometer 200 includes features and details common to the embodiments described in connection with FIGS. 1A-1D. Such common features and details generally are not repeated in order to avoid obscuring the description of the presently described embodiment.

The accelerometer 200 includes a first cantilevered transducer 201 and a second cantilevered transducer 202 provided over a substrate 203. The first cantilevered transducer 201 includes a first upper electrode 204 and the second cantilevered transducer 202 includes a second upper electrode 205. The first cantilevered transducer 201 is disposed over a first cavity 206 and the second cantilevered transducer 202 is disposed over a second cavity 207. Optionally, a single cavity may be provided, rather than two cavities as shown. The first and second cantilevered transducers 201,202 also include respective lower electrodes (not shown) and piezoelectric elements (not shown) between the respective upper and lower electrodes.

The accelerometer 200 includes a first connection 208 that connects the lower electrode (not shown) of the first cantilevered transducer 201 to the second upper electrode 205 of the second cantilevered transducer 202; and a second connection 209 connects the first upper electrode 204 to the lower electrode (not shown) of the second cantilevered transducer 202. As will be readily appreciated, the connections to the electrodes of the transducers 201, 202 are ‘crossed.’

In a representative embodiment, the cantilevered transducers 201, 202 are substantially the same and have piezoelectric elements comprised of film stacks with the neutral axis in the same plane. Illustratively, the neutral axis may be at the interface of one of the electrodes and the piezoelectric element of the cantilevered transducer. In addition, the c-axis of the piezoelectric elements for both cantilevered transducers 201, 202 are aligned in the same direction.

Application of a time-dependent electrical signal will induce motion of the transducers 201, 202 opposite to one another. In the present embodiment, an additional electrode (not shown) may be provided on a lower surface of one of the transducers 201, 202. This lower electrode is illustratively electrically isolated from the electrode used to drive the cantilevered transducer, and is capacitively coupled to the electrode in a lower surface of the cavity 206. Then a differential capacitance, of roughly the same magnitude may be established. As will be appreciated, the first cantilevered transducer 201 and electrode in the first cavity 206 provide substantially the same structure as the accelerometer 110 described in connection with FIG. 1C; and the second cantilevered transducer 202 disposed over the second cavity 207 provide substantially the same structure as the accelerometer 101 described in connection with FIG. 1A.

Known circuitry (not shown) may be implemented to garner a differential signal from the differential capacitance. Upon application of a pressure, or acceleration (e.g., along the z-axis of the reference coordinate system), deflection of the cantilevered transducers 201, 202 will be in the same direction, and will increase or decrease both capacitances simultaneously. This change in the capacitance will modulate the signals in the differential signal enabling detection of acceleration or pressure to occur.

In another illustrative embodiment, the electrode in the lower surface of the cavity is foregone. As in the previously described embodiment, the neutral axes are along one of the piezoelectric/electrode interfaces and that the c-axes of the piezoelectric elements are aligned. Furthermore, only one set of connections to the electrodes are crossed. In this embodiment, application of a bias voltage deflects the cantilevered transducers 201, 202 in opposite directions, putting the piezoelectric layer in one of the cantilevered transducers in compression and the other of the cantilevered transducers in tension. Application of a force, pressure, or acceleration, being in the same direction (e.g., the z-axis in the coordinate system shown) for each cantilevered transducer will increase compression in one and decrease tension in the other. This will increase the potential difference across one of the cantilevered transducers 201, 202 and decrease the potential difference across the other cantilevered transducer. This difference may then be extracted differentially. Usefully, the bias has a comparatively high impedance, and two of the electrodes on the cantilevered transducers 202, 202 need to have high impedance between them. Moreover, the differential readout will have a comparatively lower impedance.

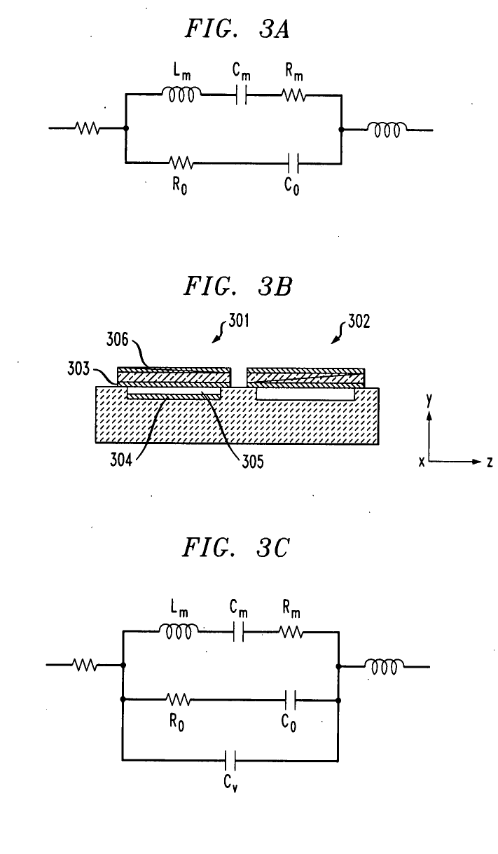

Certain embodiments contemplate at least two cantilevered transducers each operating as a resonator at parallel resonance. FIG. 3A is a simplified schematic shows a modified Butterworth-Van Dyke equivalent circuit model for a resonator of a representative embodiment. Parallel resonance occurs as a resonance between the plate capacitance C₀ and the motional inductance Lₘ. The resonant frequency fₚ may be expressed in terms of the motion capacitance, Cₘ, and C₀ and Lₘ as:

$${f}_{p} = \frac{1}{2 π} {( {L}_{m} {C}_{m} )}^{- 1 / 2} {( 1 + {C}_{m} / {C}_{0} )}^{1 / 2} \qquad Eqn . 1$$

FIG. 3B is a cross-sectional view of an accelerometer 300 in accordance with a representative embodiment. The accelerometer 300 includes certain features and details common to the embodiments described in connection with FIGS. 1A-2. Such common features and details generally are not repeated in order to avoid obscuring the description of the presently described embodiment.

In the present embodiment, a first cantilevered transducer 301 (the first resonator) operates at a slightly different resonant frequency than a second cantilevered transducer 302 (the second resonator). This difference in resonant frequency may be achieved, for example, by providing a mass loading layer to the first cantilevered transducer 301 that differs slightly relative to the mass loading layer (if any) provided to the second transducer 302.

In accordance with representative embodiments, a variable capacitance in parallel to the plate capacitance C₀ is provided to at least one of the cantilevered transducers 301, 302. FIG. 3B shows one illustrative structure for providing this variable capacitance. To this end, the first cantilevered transducer 301 includes a first lower electrode 303 that capacitively connects with an electrode 304 disposed in a first cavity 305 as shown. As will be appreciated, the electrode 304 and the first lower electrode 303 provide a structure that is substantially the same as the accelerometer 110 described in connection with FIG. 1C.

The electrode 304 selectively connects with a first upper electrode 306, thereby forming a capacitance Cᵥ in parallel with the plate capacitance Cₒ. An equivalent circuit representation for a resonator including this additional capacitance is shown in FIG. 3C. The resonant frequency depends on the variable capacitance Cᵥ according to

$${f}_{p} = \frac{1}{2 π} {( {L}_{m} {C}_{m} )}^{- 1 / 2} {( 1 + {C}_{m} / [ {C}_{0} + {C}_{v} ] )}^{1 / 2} \qquad Eqn . 2$$

When deflected by an acceleration or some other force in the y-direction of the coordinate system shown, the first cantilevered transducer 301 deflects in the −y-direction, changing the distance between the first lower electrode 303 and the electrode 304, thereby changing the capacitance Cᵥ. This variance in CV results in a ‘pulling’ of the resonant frequency fₚ, as will be appreciated from Eqn. 2. The first cantilevered transducer 301 and the second cantilevered transducer 302 may be operated to produce a beat frequency determined by the relative mass loading of the two resonators. When first cantilevered transducer 301 is deflected by an acceleration (or other force or pressure), pulling of the resonant frequency fₚ induces a modulation of this beat frequency. This modulation may then be measured in order to measure the level of deflection and subsequently the applied force, pressure, or acceleration.

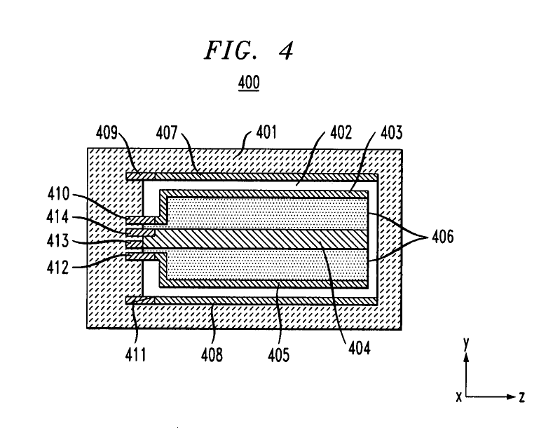

FIG. 4 is a top view of a multi-axis accelerometer 400 in accordance with a representative embodiment. The accelerometer 400 includes many features and details common to those described in connection with the embodiments of FIGS. 1A-3B. Such common features and details are generally not repeated in order to avoid obscuring the description of the present embodiments.

The accelerometer 400 includes a substrate 401 having a cavity 402 therein. A first outer electrode 403, a second outer electrode 405, and a center electrode 404 are disposed over a piezoelectric element 406. A first edge electrode 407 and a second edge electrode 408 are provided on side walls of the cavity 402. Finally, a first lower electrode (not shown) and an electrode (not shown) disposed over a bottom surface (not shown) of the cavity 402 are also provided. These electrodes are, respectively, substantially the same as electrodes 104, 112 described in conjunction with FIG. 1C, for example.

The accelerometer 400 is adapted to sense acceleration in the ±x-direction in substantially the same manner as described in connection with previously described embodiments. Additionally, the accelerometer 400 is adapted to sense acceleration in the ±y-direction. Notably, an acceleration in the +y-direction will cause a reactionary force that both causes charge displacement in the piezoelectric element 406 and results in the distance between the first outer electrode 403 and the first edge electrode 407 to become greater; and the distance between the second outer electrode 405 and the second edge electrode 408 to become smaller. As will be readily appreciated, this provides a differential capacitive measurement that is indicative of the acceleration in the +y-direction.

Mass loading layers (not shown) may be disposed over the piezoelectric element 406, or over the electrodes 404, 405, 407, or a combination thereof. As described previously, these mass loading layers usefully augment the charge displacement and movement of the cantilevered transducer due to acceleration, and thereby usefully improve the sensitivity of the cantilevered transducers to acceleration.

In representative embodiments, contacts 409 and 410 provide signals representative of the capacitance between the upper outer electrode 403 and the first edge electrode 407; and contacts 411 and 412 provide signals representative of the capacitance between the lower outer electrode 405 and the second edge electrode 408. These signals may be provided to circuitry (not shown) to provide an indication of the differential in the capacitance and thus the magnitude and direction (sign) of y-axis acceleration. Illustratively, this circuitry may be a difference amplifier known to one of ordinary skill in the art.

Contact 413 is connected to the lower electrode (not shown) and contact 414 is connected to the center electrode 404. As described in various embodiments previously, signals from these contacts are provided to circuitry to determine the magnitude and direction of x-axis acceleration.

To this point, the representative embodiments have related to accelerometers. However, gyroscopes, which are adapted to sense angular acceleration, are contemplated. Gyroscopes often require actuation of a rotor or rotational mechanism and a sense element for external perturbations imposed upon the rotor axis orientation. A change in the orientation or tilt of the rotor results in a reactive force that is measurable either in the non-inertial reference frame of the rotor or in the inertial reference frame of the device. Either actuation or sensing, or both, can be effected by a piezoelectric element such as described in connection with the accelerometers previously.

Piezoelectric cantilevers such as cantilevered transducer 101 shown in FIG. 1C, when subject to an externally applied signal will exhibit a mechanical response. This mechanical actuation can be applied asymmetrically to a piezoelectric element. For example, mechanical actuation may be applied asymmetrically to piezoelectric element 406 of the embodiment shown in FIG. 4 to create a rotational oscillation. Alternatively, the rotational actuation may be effected electromagnetically. This rotationally actuated assembly will exhibit reactive forces or displacements when subject to externally imposed perturbations to the position of the rotational axis.

Forces and displacements resulting from the perturbation of the rotational axis described can be sensed by capacitative elements or piezoelectric elements as described in connection with certain accelerometers of the representative embodiments.

The gyroscope rotor thus described may be actuated piezoelectrically and reaction to an imposed rotational perturbation may be sensed piezoelectrically or capacitatively. Alternatively, the gyroscope rotor may be actuated electromagnetically and the reaction to an externally applied perturbation measured piezoelectrically.

In connection with illustrative embodiments, piezoelectric accelerometers and gyroscopes are described. One of ordinary skill in the art appreciates that many variations that are in accordance with the present teachings are possible and remain within the scope of the appended claims. These and other variations would become clear to one of ordinary skill in the art after inspection of the specification, drawings and claims herein. The invention therefore is not to be restricted except within the spirit and scope of the appended claims.

1. An accelerometer, comprising:
a substrate having a cavity;
a cantilevered transducer disposed over the cavity and having an upper electrode, a lower electrode and a piezoelectric element therebetween, wherein an acceleration causes a movement of the cantilevered transducer that is proportional to a magnitude of the acceleration.

2. An accelerometer as claimed in claim 1, further comprising an electrode disposed along a lower surface of the cavity, wherein the lower electrode and the electrode comprise a capacitor, having a capacitance that varies in response to the movement of cantilevered transducer.

3. An accelerometer as claimed in claim 2, wherein the cantilevered transducer is driven to oscillate at an oscillation frequency and the capacitor and the cantilevered transducer further comprise a resonator circuit having a frequency that varies with the variance in the capacitance.

4. An accelerometer as claimed in claim 3, further comprising a second cantilevered transducer driven to oscillate substantially at the oscillation frequency, wherein an output of the resonator circuit is combined with an output of the second cantilevered transducer, to provide a signal indicative of the magnitude of the acceleration.

5. An accelerometer as claimed in claim 3, further comprising a second cantilevered transducer driven to oscillate at a second oscillation frequency that is different from the oscillation frequency, wherein an output of the resonator circuit is combined with an output of the second cantilevered transducer to provide a signal indicative of a magnitude of an acceleration.

6. An accelerometer as claimed in claim 1, further comprising a mass loading layer disposed over the upper electrode.

7. An accelerometer as claimed in claim 1, wherein the cantilevered transducer is connected at least partially about a perimeter of the cavity.

8. An accelerometer as claimed in claim 1, wherein an areal shape of the cantilevered transducer is one of: rectangular, square, elliptical, circular or irregular.

9. An accelerometer, comprising:
a substrate having a cavity with a lower surface and a side surface;
a cantilevered transducer comprising:
a piezoelectric element having an upper surface and a lower surface;
a first edge electrode and an upper electrode each disposed over the upper surface; and a lower electrode disposed over the lower surface of the piezoelectric element;
a second edge electrode disposed over the side surface of the cavity; and
an electrode disposed over the lower surface of the cavity.

10. An accelerometer as claimed in claim 9, wherein the first and second edge electrodes comprise a first capacitor.

11. An accelerometer as claimed in claim 9, wherein the electrode disposed over the lower surface of the cavity and the lower electrode comprise a second capacitor.

12. An accelerometer as claimed in claim 10, wherein an acceleration in a first direction causes a change in a capacitance of the first capacitor.

13. An accelerometer as claimed in claim 11, wherein an acceleration in a second direction causes a change in a capacitance of the second capacitor.

14. An accelerometer as claimed in claim 12, wherein the cantilevered transducer is driven to oscillate at an oscillation frequency and the first capacitor and the cantilevered transducer further comprise a resonator circuit having a resonance frequency that varies with the change in the capacitance of the first capacitor.

15. An accelerometer as claimed in claim 14, comprising a second cantilevered transducer driven to oscillate at a second oscillation frequency that is different from the oscillation frequency, wherein an output of the resonator circuit is combined with an output of the second cantilevered transducer to provide a signal indicative of a magnitude of an acceleration.

16. An accelerometer as claimed in claim 13, wherein the cantilevered transducer is driven to oscillate at an oscillation frequency and the second capacitor and the cantilevered transducer further comprise a resonator circuit having a frequency that varies with the variance in the capacitance of the second capacitor.

17. An accelerometer as claimed in claim 9, further comprising at least one mass loading layer.

18. A gyroscope, comprising:
a substrate having a cavity;
a cantilevered transducer disposed over the cavity and having an upper electrode, a lower electrode and a piezoelectric element therebetween.

19. A gyroscope as claimed in claim 18, further comprising:
a layer of piezoelectric material having an upper surface and a lower surface; a first edge electrode and an upper electrode each disposed over the upper surface; and a lower electrode disposed over the lower surface of the piezoelectric material;
a second edge electrode disposed over the side surface of the cavity.
